(19) United States
(12) Patent Application Publication
(10) Pub. No.: US 2004/0013247 A1
(43) Pub. Date: Jan. 22, 2004

(54) Internal information sharing system, call connection control server, wireless LAN telephone terminal apparatus and internal information sharing method thereof

(75) Inventor: Hideki Kurokawa, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/619,562

(22) Filed: Jul. 16, 2003

(30) Foreign Application Priority Data
Jul. 17, 2002 (JP) 2002-207653

(51) Int. Cl. H04M 1/64; H04L 12/28; H04M 11/00

(52) U.S. Cl. 379/88.17; 379/219; 370/395.53; 455/403

(57) ABSTRACT

To provide a wireless LAN telephone terminal apparatus capable of unifying management of telephone directory data and call originating/incoming history.

If connection with a radio base station is completed, a wireless LAN telephone terminal apparatus requests a database of a call connection control server to associate a telephone number with an IP address. The call connection control server registers the telephone number and IP address of the wireless LAN telephone terminal apparatus with the database, and transmits history information and telephone directory data on the IP telephone or PC set in advance to the wireless LAN telephone terminal apparatus together with time information. Thereafter, the wireless LAN telephone terminal apparatus performs call origination and call termination via the call connection control server as long as it is connected to an Internet or intranet line, and so each call generated is registered with the database.

### BACKGROUND OF THE INVENTION

1. Field of the Invention

The present invention relates to an internal information sharing system, a call connection control server, a wireless LAN telephone terminal apparatus and an internal information sharing method and a program thereof, and in particular, to a wireless telephone terminal apparatus for utilizing voice by connecting to the Internet or an intranet.

2. Description of the Related Art

In the past, as for IP telephone software for utilizing voice communication by an LAN (Local Area Network) line on an IP (Internet Protocol) telephone and a personal computer (hereafter, referred to as a PC) connected to the LAN line, a telephone directory and call originating/incoming history are stored in an storage area of the IP telephone and a storage device inside the PC having the IP telephone software so as to be utilized.

As for a portable telephone terminal utilizing a wireless line in the past, information on each of the telephone directory and call originating/incoming history is stored in the storage device inside the portable telephone terminal so as to be utilized.

As for the IP telephone or the PC having IP telephone software utilizing the LAN line in the past and a portable telephone apparatus utilizing the wireless line, telephone number information handled on call origination and call termination is stored in each storage device so as to be utilized only by the devices storing it.

As for a method of utilizing it in an office, for instance, a user uses the IP telephone or the PC having the IP telephone software on the desk while staying at his or her own desk, and transfers the call to the portable telephone terminal when leaving the desk during a call.

Management of the telephone directory and call originating/incoming history information is limited to inside of each of the IP telephone, the PC having the IP telephone software and the portable telephone terminal in the past.

For instance, there is a problem that, when calling back by the portable telephone terminal the other party whose call was received by the IP telephone, a cumbersome operation is necessary such as browsing the call incoming history of the IP telephone once and dialing on the portable telephone terminal.

As for the past technology, there is a problem that, when updating telephone directory information already registered, it is necessary to update the respective information on the IP telephone or the PC having the IP telephone software and the portable telephone terminal.

Furthermore, as to the past technology, there is a problem that the call is transferred to the portable telephone terminal when leaving the desk during a call as described above, and so an originator number becomes a telephone number of the IP telephone or the IP telephone software utilizing the PC of a transfer source so that an inconsistency arises as to a call destination telephone number when calling back from the portable telephone terminal later.

### SUMMARY OF THE INVENTION

An object of the present invention is to provide an internal information sharing system, a call connection control server, a wireless LAN telephone terminal apparatus and an internal information sharing method and a program thereof capable of solving the above problems and unifying the management of the telephone directory data and call originating/incoming history.

An internal information sharing system according to the present invention is the one including various device terminals having a telephone function and a control unit for making a call connection on call origination and call termination by each of the above described various device terminals, wherein the above described system has:

means for sending and receiving a call control message between each of the above described various device terminals and the above described control unit;

a storage device for storing information on the above described call control message together with time information; and

means for, when each of the above described various device terminals registers information with the above described control unit, transmitting the information already registered with the above described storage device to each of the above described various device terminals.

A call connection control server according to the present invention is the one for making a call connection on call origination and call termination by at least one of the IP (Internet Protocol) telephone and the information processing apparatus having the IP telephone software connected to an LAN (Local Area Network) line respectively and a wireless LAN telephone terminal apparatus capable of making voice communication with them by connecting to a wireless LAN line, wherein the above described server has:

means for sending and receiving a call control message to and from the above described wireless LAN telephone terminal apparatus;

a storage device for storing information on the above described call control message together with time information; and

means for, when the above described wireless LAN telephone terminal apparatus registers its location via the above described wireless LAN line, transmitting the information already registered with the above described storage device to the above described wireless LAN telephone terminal apparatus.

A wireless LAN telephone terminal apparatus according to the present invention is the one capable of making voice communication by connecting via the wireless LAN line to at least one of the IP (Internet Protocol) telephone and the information processing apparatus having the IP telephone software connected to the LAN (Local Area Network) line respectively, wherein the above described apparatus has:

means for sending and receiving the call control message to and from a call connection control server for making a call connection on call origination and call termination by at least one of the above described IP telephone and the above described information processing apparatus; and

means for, when the information already registered with the storage device for storing the information on the above described call control message together with the time information is transmitted to the wireless LAN telephone terminal apparatus on registering a location of the wireless LAN telephone terminal apparatus via the above described wireless LAN line, storing the information in an internal storage area.

An internal information sharing method according to the present invention is the one of a system including the various device terminals having the telephone function and the control unit for making a call connection on call origination and call termination by each of the above described various device terminals, wherein the above described method has:

a step of sending and receiving the call control message between each of the above described various device terminals and the above described control unit; and

a step of, when each of the above described various device terminals registers information with the above described control unit, transmitting to each of the above described various device terminals the information already registered with the storage device for storing information on the above described call control message together with time information.

A program of an internal information sharing method according to the present invention is the one of a system including the various device terminals having the telephone function and the control unit for making a call connection on call origination and call termination by each of the above described various device terminals, wherein the above described program causes a computer to execute:

a process of sending and receiving the call control message between each of the above described various device terminals and the above described control unit; and

a process of, when each of the above described various device terminals registers information with the above described control unit, transmitting to each of the above described various device terminals the information already registered with the above described storage device for storing the information on the above described call control message together with time information.

To be more specific, the wireless LAN telephone terminal apparatus according to the present invention is capable of making voice communication by connecting by the wireless LAN line to the IP (Internet Protocol) telephone or a personal computer (hereafter, referred to as a PC) having the IP telephone software connected to an LAN (Local Area Network) line.

The present invention has a mechanism for sharing the telephone directory and call originating/incoming history in the wireless LAN telephone terminal apparatus. Thus, according to the present invention, it is possible to synchronize the telephone directory and call originating/incoming history information so as to eliminate the above-mentioned cumbersome operation in the past.

The present invention also has a mechanism for sharing call control and line information in the wireless LAN telephone terminal apparatus. Thus, according to the present invention, no inconsistency arises to a call destination number when calling back as above.

To describe it more concretely, according to the present invention, the call control message according to each operation is sent and received to and from the call connection control server for making a call connection on call origination and call termination by the IP telephone or the PC having the IP telephone software and the wireless LAN telephone terminal apparatus.

The call originating/incoming history were stored in a storage area of each terminal in the past. According to the present invention, however, such information is also stored in an external storage device of the call connection control server together with the time information.

When having the wireless LAN telephone terminal apparatus connected to a network via the wireless LAN line and registering its location with the call connection control server, the above information already registered is transmitted to the wireless LAN telephone terminal apparatus together with the time information via the wireless LAN line so that it becomes possible to unify the management of the above information between the IP telephone or the PC having the IP telephone software and the wireless LAN telephone terminal apparatus.

As the wireless LAN telephone terminal apparatus may move to an external network, the history information on call origination and call termination in the external network is stored in the storage area inside the wireless LAN telephone terminal apparatus, and when having the location of the wireless LAN telephone terminal apparatus registered with the same network (home network) as the IP telephone or the PC having the IP telephone software, the stored information is transmitted to the external storage device of the call connection control server so as to unify the management of the above information.

Furthermore, according to the present invention, it is possible, by sharing the call control and line information with the IP telephone or the PC having the IP telephone software while having the location registered with the home network, to unify management of calls so as to easily deliver the calls without performing the cumbersome operation.

As described above, it is possible, with the wireless LAN telephone terminal apparatus according to the present invention, to unify the management of the telephone directory data and call originating/incoming history between the wireless LAN telephone terminal apparatus and the IP telephone or the PC having the IP telephone software on the desk.

It is possible, with the wireless LAN telephone terminal apparatus according to the present invention, to synchronize the call control information and line information with the IP telephone or the PC having the IP telephone software on the desk so as to enhance mobility unique to a wireless apparatus without necessity of a cumbersome transfer operation even when leaving the desk during the voice communication.

Furthermore, according to the present invention, it is possible, by mutually giving and receiving peer-to-peer the telephone directory data and call originating/incoming history between the IP telephone or the PC having the IP telephone software on the desk and wireless LAN telephone terminal apparatus so as to unify the management of the telephone directory data and call originating/incoming history.

Furthermore, according to the present invention, the call control message according to each operation is sent and received to and from the private branch exchange for making a call connection on call origination and call termination by a digital multifunctional telephone and a uPCS (unlicensed Personal Communication System) handset, and so such information is stored in the external storage device of the private branch exchange together with the time information.

It is possible, when the uPCS handset registers its location with the private branch exchange, to transmit to the uPCS handset the above information already registered together with time information so as to unify the management of the above information between the digital multifunctional telephone and the uPCS handset.

### BRIEF DESCRIPTION OF THE DRAWINGS

FIG. 1 is a block diagram showing a configuration of a network according to an embodiment of the present invention;

FIG. 2 is a block diagram showing the configuration of the wireless LAN telephone terminal apparatus in FIG. 1;

FIG. 3 is a block diagram showing the configurations of a call connection control server and a database in FIG. 1;

FIG. 4 is a flowchart showing an operation of the wireless LAN telephone terminal apparatus in FIG. 1;

FIG. 5 is a flowchart showing the operation of the wireless LAN telephone terminal apparatus in FIG. 1;

FIG. 6 is a flowchart showing the operation of the wireless LAN telephone terminal apparatus in FIG. 1;

FIG. 7 is a flowchart showing the operation of the call connection control server in FIG. 1;

FIG. 8 is a flowchart showing the operation of the call connection control server in FIG. 1;

FIG. 9 is a flowchart showing the operation of the call connection control server in FIG. 1;

FIG. 10 is a sequence chart showing the operation of a network according to an embodiment of the present invention; and

FIG. 11 is a block diagram showing the configuration of the network according to another embodiment of the present invention.

### DETAILED DESCRIPTION OF THE PREFERRED EMBODIMENTS

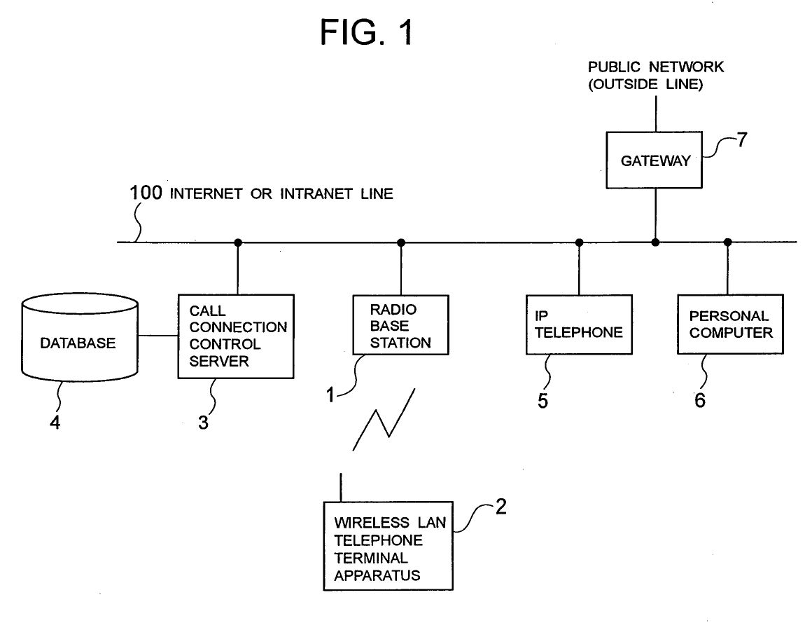

Next, the embodiments of the present invention will be described by referring to the drawings. FIG. 1 is a block diagram showing a configuration of a network according to an embodiment of the present invention. In FIG. 1, the network according to the embodiment of the present invention is comprised of a radio base station 1, a wireless LAN (Local Area Network) telephone terminal apparatus 2, a call connection control server 3, a database 4, an IP (Internet Protocol) telephone 5, a personal computer (hereafter, referred to as a PC) 6 having IP telephone software and a gateway 7 for connecting to a public network (not shown).

The radio base station 1, call connection control server 3, IP telephone 5, PC 6 and gateway 7 are connected to an Internet or intranet line 100 respectively. The radio base station 1 connects the wireless LAN telephone terminal apparatus 2 to the Internet or intranet line 100.

The wireless LAN telephone terminal apparatus 2 searches radio waves in the surroundings with a radio receiving circuit, and if it recognizes the radio base station 1, it starts to request a connection to the network. On completion of the connection to the radio base station 1, the wireless LAN telephone terminal apparatus 2 requests the database 4 of the call connection control server 3 to associate a telephone number with an IP address.

The call connection control server 3 registers the telephone number and IP address of the wireless LAN telephone terminal apparatus 2 with the database 4, and transmits history information and telephone directory data on the IP telephone 5 or PC 6 associated with the wireless LAN telephone terminal apparatus 2 in advance to the wireless LAN telephone terminal apparatus 2 together with time information.

Thereafter, the wireless LAN telephone terminal apparatus 2 performs call origination and call termination via the call connection control server 3 as long as it is connected to the Internet or intranet line 100, and so each call generated is registered with the database 4 so as to unify management of synchronous data including at least the history information and telephone directory data between it and the IP telephone 5 or PC 6.

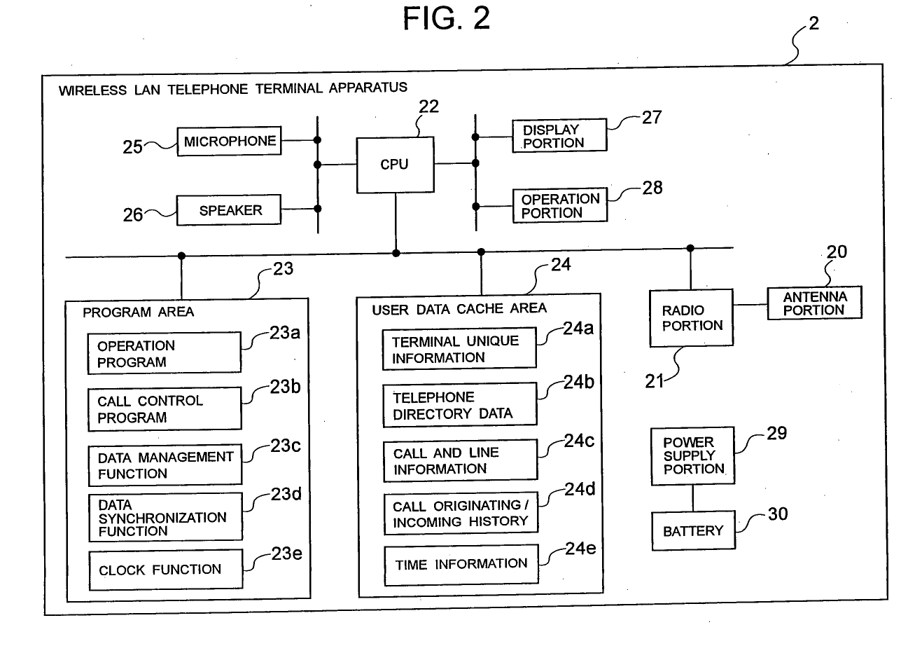

FIG. 2 is a block diagram showing the configuration of the wireless LAN telephone terminal apparatus 2 in FIG. 1. In FIG. 2, the wireless LAN telephone terminal apparatus 2 is comprised of an antenna portion 20, a radio portion 21, a CPU (Central Processing Unit) 22, a program area 23 of a storage portion, a user data cache area 24 of the storage portion, a microphone 25, a speaker 26, a display portion 27, an operation portion 28, a power supply portion 29 and a battery 30.

The program area 23 of the storage portion has the areas of an operation program 23a, a call control program 23b, a data management function 23c, a data synchronization function 23d and a clock function 23e provided therein. The user data cache area 24 of the storage portion has the areas of terminal unique information 24a, telephone directory data 24b, call and line information 24c, call origination and call termination history (call originating/incoming history) 24d and time information 24e provided therein.

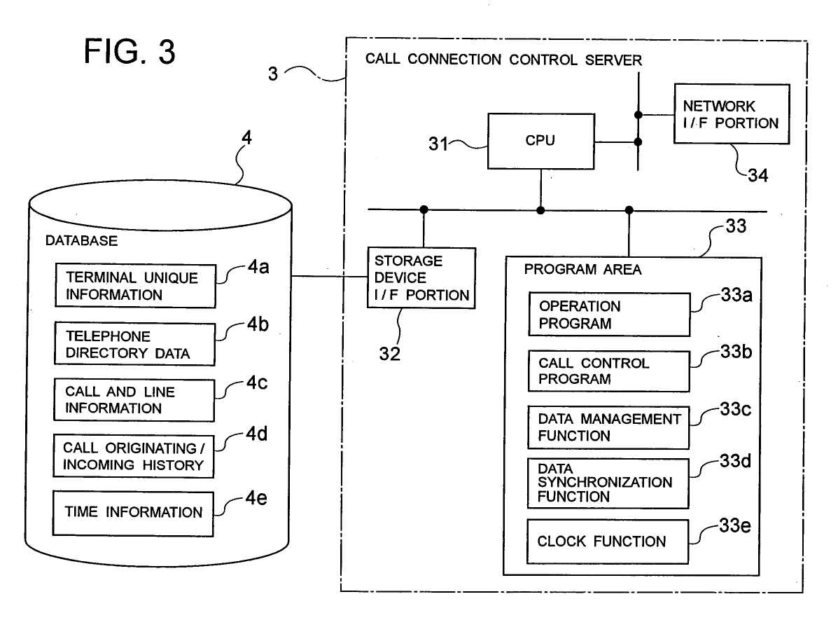

FIG. 3 is a block diagram showing the configurations of the call connection control server 3 and the database 4. In FIG. 3, the call connection control server 3 is comprised of a CPU 31, a storage device interface (I/F) portion 32, a program area 33 of a storage portion and a network interface (I/F) portion 34.

The program area 33 of the storage portion has the areas of an operation program 33a, a call control program 33b, a data management function 33c, a data synchronization function 33d and a clock function 33e provided therein.

The database 4 has the areas of terminal unique information 4a, telephone directory data 4b, call and line information 4c, call origination and call termination history 4d and time information 4e provided therein.

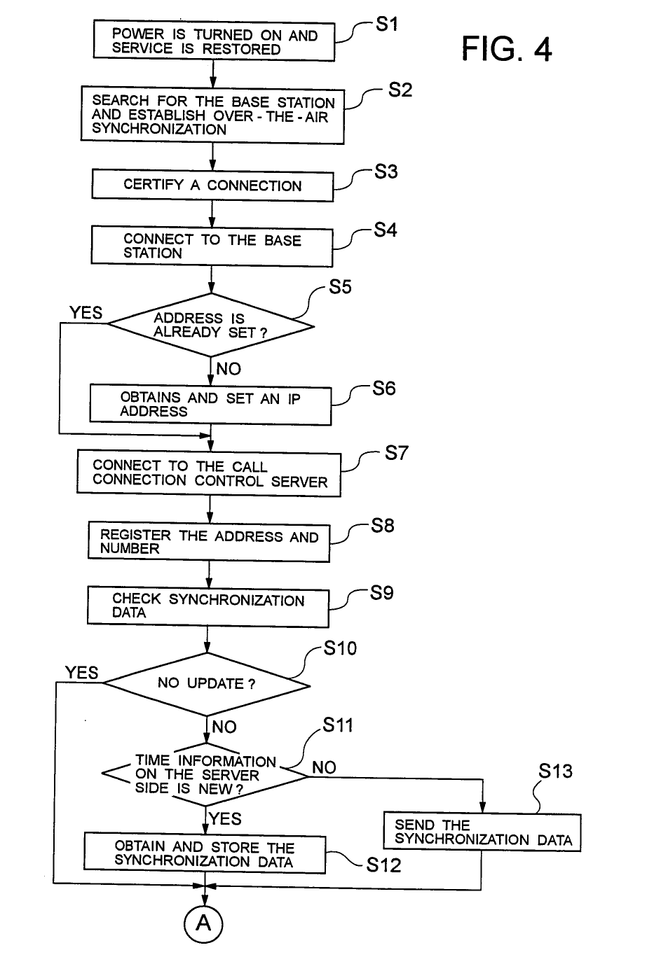

FIGS. 4 to 6 are flowcharts showing the operation of the wireless LAN telephone terminal apparatus 2 in FIG. 1. The operation of the wireless LAN telephone terminal apparatus 2 will be described by referring to FIGS. 1 and 2 and FIGS. 4 to 6. The processes shown in FIGS. 4 to 6 are implemented by having a program in the program area 23 of the storage portion executed by a computer (not shown) in the wireless LAN telephone terminal apparatus 2.

If the power is turned on and service is restored (step Si in FIG. 4), the wireless LAN telephone terminal apparatus 2 searches for the radio base station 1 and establishes over-the-air synchronization (step S2 in FIG. 4). Thereafter, the wireless LAN telephone terminal apparatus 2 certifies a connection with the radio base station 1 (step S3 in FIG. 4) so as to connect to the radio base station 1 (step S4 in FIG. 4).

On connecting to the radio base station 1, the wireless LAN telephone terminal apparatus 2 moves on to a step S7 if the address is already set (step S5 in FIG. 4). If the address is not set (step S5 in FIG. 4), the wireless LAN telephone terminal apparatus 2 obtains the IP address and sets it inside (step S6 in FIG. 4).

After connecting to the call connection control server 3 (step S7 in FIG. 4) and registering the address and telephone number (step S8 in FIG. 4), the wireless LAN telephone terminal apparatus 2 checks synchronization data (including the telephone directory data, history information, call control information and line information) in its own storage portion against the synchronization data in the database 4 (step S9 in FIG. 4). Consequently, if there is no update (step S10 in FIG. 4), the wireless LAN telephone terminal apparatus 2 moves on to a step S14.

If there is an update (step S10 in FIG. 4), the wireless LAN telephone terminal apparatus 2 checks whether or not the time information (updated time information) on the call connection control server 3 side is newer than the time information on the wireless LAN telephone terminal apparatus 2 side (step S11 in FIG. 4). Consequently, if the time information on the call connection control server 3 side is new, the wireless LAN telephone terminal apparatus 2 obtains the synchronization data from the call connection control server 3 and stores it in the user data cache area 24 of the storage portion (step S12 in FIG. 4). If the time information on the call connection control server 3 side is not new, the wireless LAN telephone terminal apparatus 2 sends the synchronization data to the call connection control server 3 (step S13 in FIG. 4).

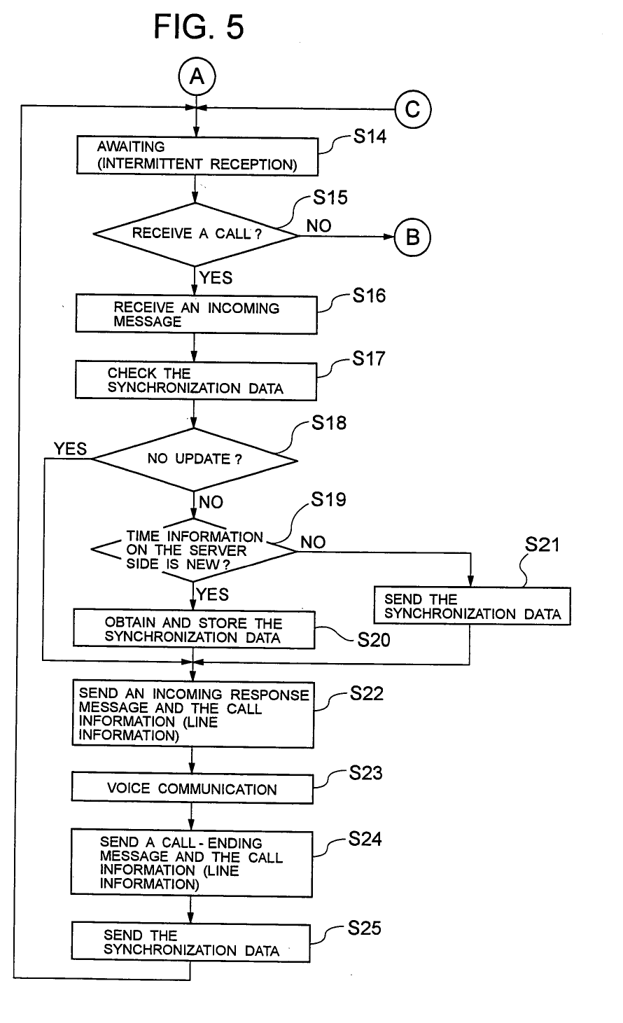

After the above processing, the wireless LAN telephone terminal apparatus 2 moves on to a state of awaiting the call origination and call termination (intermittent reception state (idle state)) (step S14 in FIG. 5), and if an incoming call is received (step S15 in FIG. 5), it receives an incoming message (step S16 in FIG. 5) so as to check the synchronization data (step S17 in FIG. 5).

If there is the update (step S18 in FIG. 5), the wireless LAN telephone terminal apparatus 2 checks whether or not the time information on the call connection control server 3 side is new (step S19 in FIG. 5). Consequently, if the time information on the call connection control server 3 side is new, the wireless LAN telephone terminal apparatus 2 obtains the synchronization data from the call connection control server 3 and stores it in the user data cache area 24 of the storage portion (step S20 in FIG. 5). If the time information on the call connection control server 3 side is not new, the wireless LAN telephone terminal apparatus 2 sends the synchronization data to the call connection control server 3 (step S21 in FIG. 5).

Thereafter, the wireless LAN telephone terminal apparatus 2 sends an incoming response message and the call information (line information) to the call connection control server 3 (step S22 in FIG. 5). Thus, the wireless LAN telephone terminal apparatus 2 becomes capable of voice communication with the other party (originator) and the voice communication is performed (step S23 in FIG. 5).

If the voice communication with the other party is finished, the wireless LAN telephone terminal apparatus 2 sends a call-ending message and the call information (line information) to the call connection control server 3 (step S24 in FIG. 5), and sends the updated call incoming history and the information on the other party's registration with the telephone directory as the synchronization data to the call connection control server 3 (step S25 in FIG. 5). Thereafter, the wireless LAN telephone terminal apparatus 2 returns to the step S14 to be in the idle state.

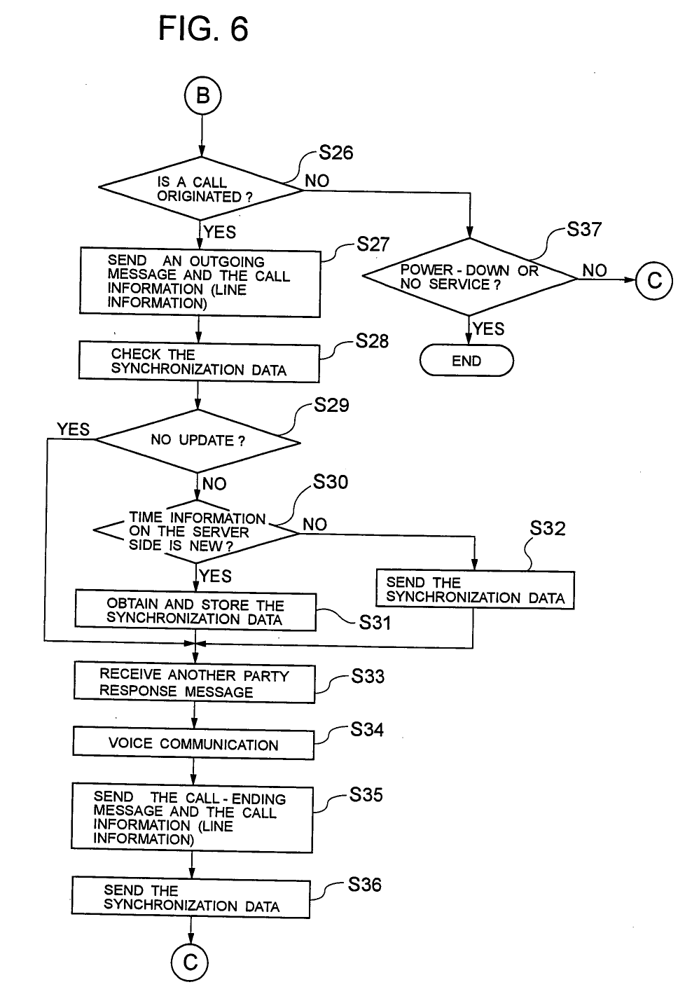

In the case of originating a call (step S26 in FIG. 6), the wireless LAN telephone terminal apparatus 2 sends an outgoing message and the call information (line information) to the call connection control server 3 (step S27 in FIG. 6) so as to check the synchronization data (step S28 in FIG. 6).

If there is the update (step S29 in FIG. 6), the wireless LAN telephone terminal apparatus 2 checks whether or not the time information on the call connection control server 3 side is new (step S30 in FIG. 6). Consequently, if the time information on the call connection control server 3 side is new, the wireless LAN telephone terminal apparatus 2 obtains the synchronization data from the call connection control server 3 and stores it in the user data cache area 24 of the storage portion (step S31 in FIG. 6). If the time information on the call connection control server 3 side is not new, the wireless LAN telephone terminal apparatus 2 sends the synchronization data to the call connection control server 3 (step S32 in FIG. 6).

Thereafter, the wireless LAN telephone terminal apparatus 2 sends another party response message to the call connection control server 3 (step S33 in FIG. 6). Thus, the wireless LAN telephone terminal apparatus 2 becomes capable of voice communication with the other party (destination of the call) and the voice communication is performed (step S34 in FIG. 6).

If the voice communication with the other party is finished, the wireless LAN telephone terminal apparatus 2 sends the call-ending message and the call information (line information) to the call connection control server 3 (step S35 in FIG. 6), and sends the information on the updated call originating history as the synchronization data to the call connection control server 3 (step S36 in FIG. 6). Thereafter, the wireless LAN telephone terminal apparatus 2 returns to the step S14 to be in the idle state.

If the power is turned off or the wireless LAN telephone terminal apparatus 2 leaves the service area (step S37 in FIG. 6), the wireless LAN telephone terminal apparatus 2 finishes the processing. If the wireless LAN telephone terminal apparatus 2 exists in the service area without turning off the power (step S37 in FIG. 6), the wireless LAN telephone terminal apparatus 2 returns to the step S14 to be in the idle state. The processes shown in FIGS. 4 to 6 are also applicable to the IP telephone 5 and PC 6.

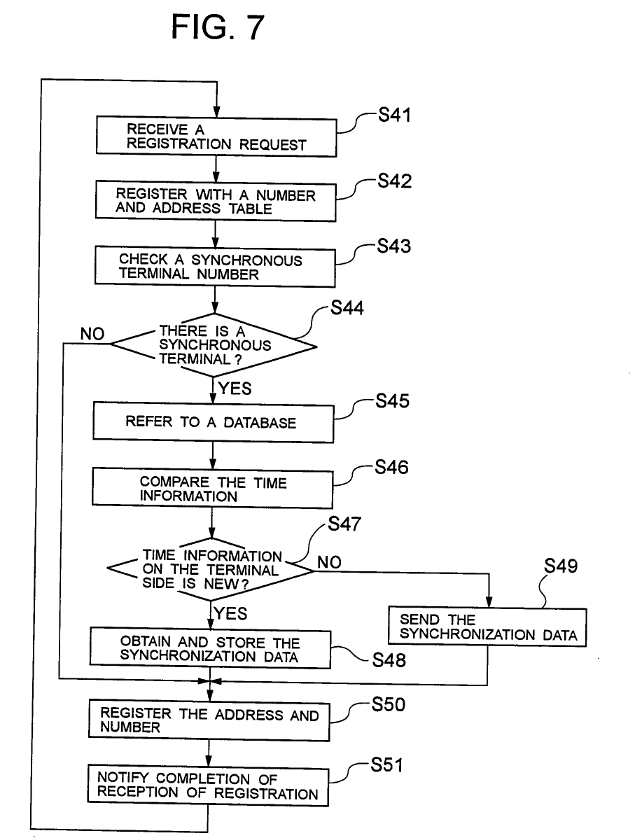

FIGS. 7 to 9 are the flowcharts showing the operation of the call connection control server 3 in FIG. 1. The operation of the call connection control server 3 will be described by referring to FIGS. 1 and 3 and FIGS. 7 to 9. The processes shown in FIGS. 7 to 9 are implemented by having the program in the program area 33 of the storage portion executed by a computer (not shown) in the call connection control server 3.

On receiving a registration request from the wireless LAN telephone terminal apparatus 2 (step S41 in FIG. 7), the call connection control server 3 registers with a number and address table (not shown) the telephone number and IP address from the wireless LAN telephone terminal apparatus 2 (step S42 in FIG. 7).

Thereafter, the call connection control server 3 checks whether or not there is a synchronous terminal (IP telephone 5 or PC 6) associated with the wireless LAN telephone terminal apparatus 2 based on a synchronous terminal number (number of the wireless LAN telephone terminal apparatus 2) (step S43 in FIG. 7). If there is no synchronous terminal (step S44 in FIG. 7), the call connection control server 3 moves on to a step S50. If there is the synchronous terminal (step S44 in FIG. 7), the call connection control server 3 refers to the database 4 (step S45 in FIG. 7) so as to compare the time information (step S46 in FIG. 7).

On determining that the time information on the wireless LAN telephone terminal apparatus 2 side is new by the above comparison (step S47 in FIG. 7), the call connection control server 3 obtains the synchronization data from the wireless LAN telephone terminal apparatus 2 and stores it in the database 4 (step S48 in FIG. 7). On determining that the time information on the wireless LAN telephone terminal apparatus 2 side is not new by the above comparison (step S47 in FIG. 7), the call connection control server 3 sends the synchronization data of the database 4 to the wireless LAN telephone terminal apparatus 2 (step S49 in FIG. 7).

Thereafter, the call connection control server 3 registers the address and number of the wireless LAN telephone terminal apparatus 2 (step S50 in FIG. 7), and notifies the wireless LAN telephone terminal apparatus 2 of completion of reception of the registration (step S51 in FIG. 7) and then waits for a next registration.

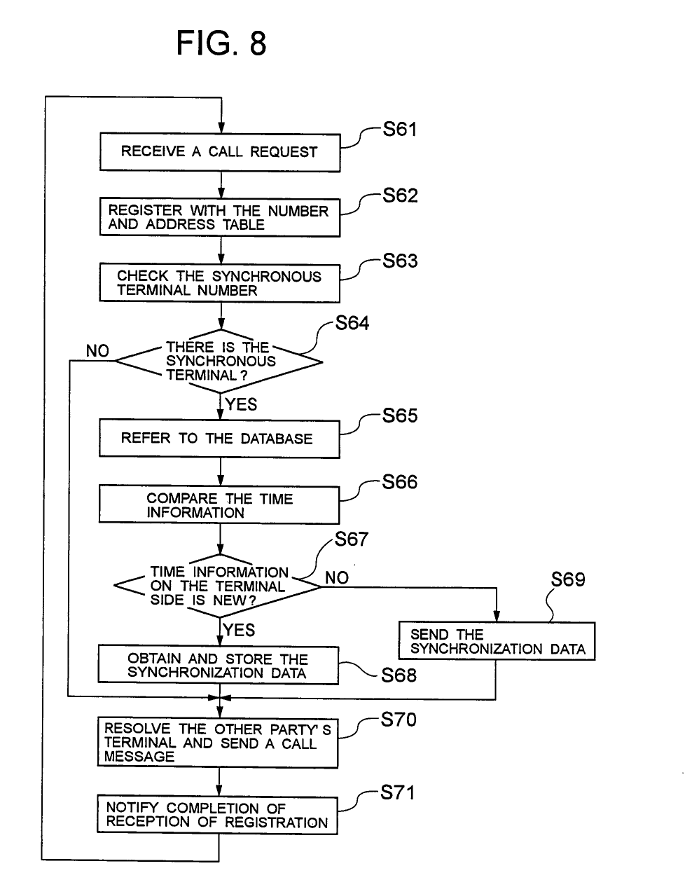

On receiving a call request from the wireless LAN telephone terminal apparatus 2 (step S61 in FIG. 8), the call connection control server 3 registers with the number and address table the number and address of the wireless LAN telephone terminal apparatus 2 (step S62 in FIG. 8).

Thereafter, the call connection control server 3 checks whether or not there is a synchronous terminal (IP telephone 5 or PC 6) associated with the wireless LAN telephone terminal apparatus 2 based on the synchronous terminal number (number of the wireless LAN telephone terminal apparatus 2) (step S63 in FIG. 8). If there is no synchronous terminal (step 64 in FIG. 8), the call connection control server 3 moves on to a step S70. If there is the synchronous terminal (step S64 in FIG. 8), the call connection control server 3 refers to the database 4 (step S65 in FIG. 8) so as to compare the time information (step S66 in FIG. 8).

On determining that the time information on the wireless LAN telephone terminal apparatus 2 side is new by the above comparison (step S67 in FIG. 8), the call connection control server 3 obtains the synchronization data from the wireless LAN telephone terminal apparatus 2 and stores it in the database 4 (step S68 in FIG. 8). On determining that the time information on the wireless LAN telephone terminal apparatus 2 side is not new by the above comparison (step S67 in FIG. 8), the call connection control server 3 sends the synchronization data of the database 4 to the wireless LAN telephone terminal apparatus 2 (step S69 in FIG. 8).

Thereafter, the call connection control server 3 resolves the other party's terminal (destination of the call) and sends a call message (step S70 in FIG. 8), and then notifies the wireless LAN telephone terminal apparatus 2 of completion of reception of the registration (step S71 in FIG. 8) so as to wait for the next registration.

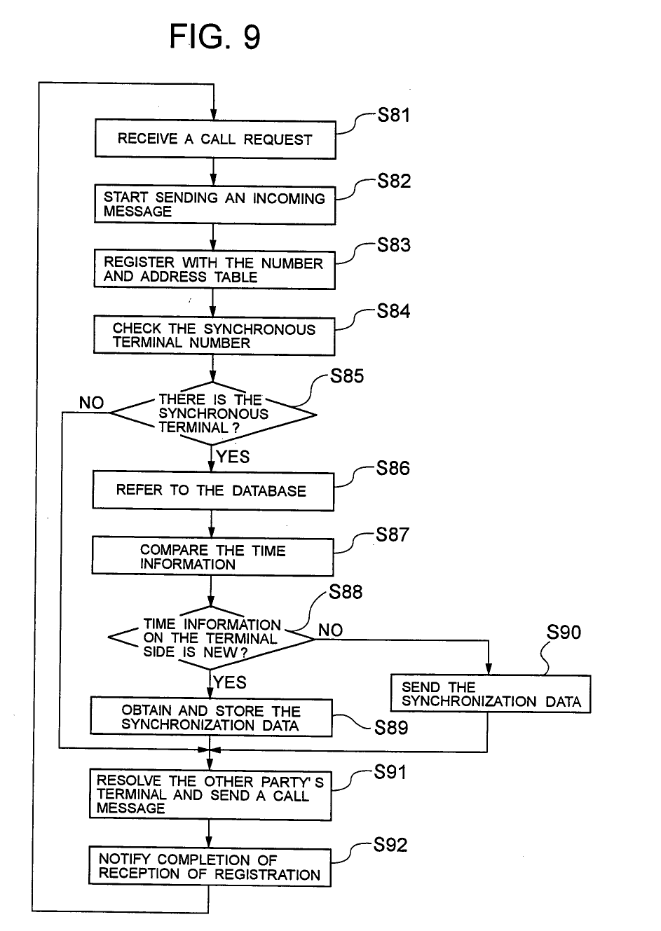

On receiving a call request from the wireless LAN telephone terminal apparatus 2 (step S81 in FIG. 9), the call connection control server 3 starts an operation for sending the incoming message (step S82 in FIG. 9), and registers with the number and address table the number and address of the wireless LAN telephone terminal apparatus 2 (step S83 in FIG. 9).

Thereafter, the call connection control server 3 checks whether or not there is a synchronous terminal (IP telephone 5 or PC 6) associated with the wireless LAN telephone terminal apparatus 2 based on the synchronous terminal number (number of the wireless LAN telephone terminal apparatus 2) (step S84 in FIG. 9). If there is no synchronous terminal (step 85 in FIG. 9), the call connection control server 3 moves on to a step S91. If there is the synchronous terminal (step S85 in FIG. 9), the call connection control server 3 refers to the database 4 (step S86 in FIG. 9) so as to compare the time information (step S87 in FIG. 9).

On determining that the time information on the wireless LAN telephone terminal apparatus 2 side is new by the above comparison (step S88 in FIG. 9), the call connection control server 3 obtains the synchronization data from the wireless LAN telephone terminal apparatus 2 and stores it in the database 4 (step S89 in FIG. 9). On determining that the time information on the wireless LAN telephone terminal apparatus 2 side is not new by the above comparison (step S88 in FIG. 9), the call connection control server 3 sends the synchronization data of the database 4 to the wireless LAN telephone terminal apparatus 2 (step S90 in FIG. 9).

Thereafter, the call connection control server 3 resolves the other party's terminal (destination of the call) and sends a call message (step S91 in FIG. 9), and then notifies the wireless LAN telephone terminal apparatus 2 of completion of the reception of the registration (step S92 in FIG. 9) so as to wait for the next registration. The processes shown in FIGS.7 to 9 are intended for the wireless LAN telephone terminal apparatus 2 but are also applicable to the cases where the IP telephone 5 and PC 6 are the subjects.

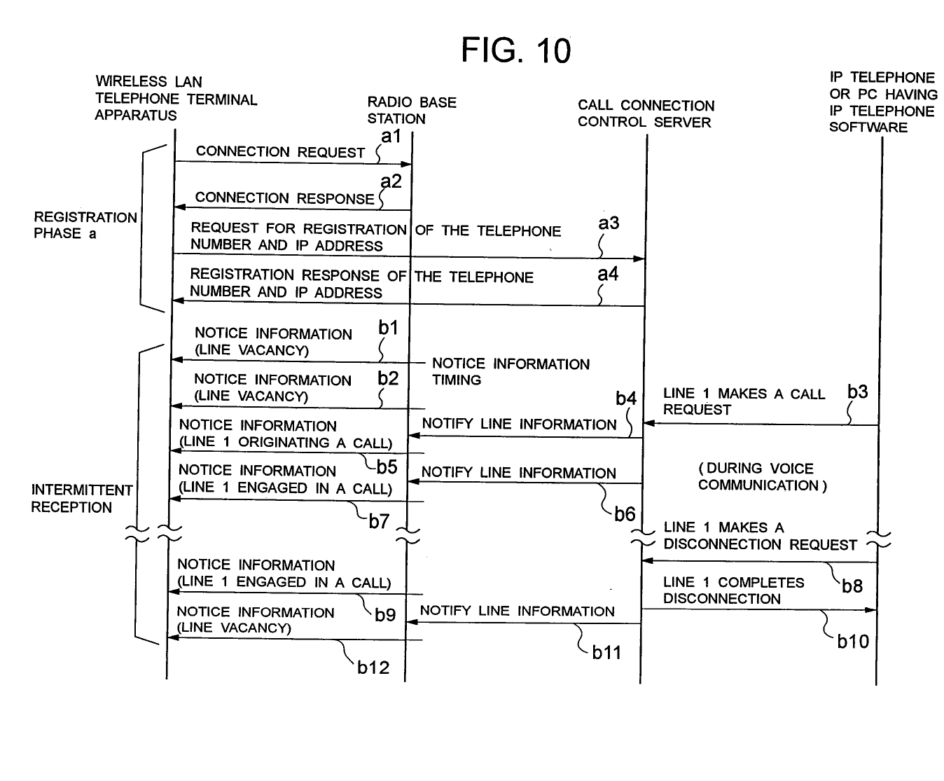

FIG. 10 is a sequence chart showing the operation of the network according to the embodiment of the present invention. FIG. 10 shows the operation for sharing the call control information and line information among the wireless LAN telephone terminal apparatus 2, radio base station 1, call connection control server 3, IP telephone 5 and PC 6.

First, in order to allow the call origination and call termination of telephone calls via the call connection control server 3, the wireless LAN telephone terminal apparatus 2 sends a connection request to the radio base station 1 (a1 in FIG. 10), and if it receives a connection response from the radio base station 1 (a2 in FIG. 10), it sends a request for registration of the telephone number and IP address to the call connection control server 3 (a3 in FIG. 10).

The call connection control server 3 registers the telephone number and IP address of the wireless LAN telephone terminal apparatus 2 with the database 4, and sends a registration response of the telephone number and IP address to the wireless LAN telephone terminal apparatus 2 (a4 in FIG. 10).

The above process is a registration phase a of the wireless LAN telephone terminal apparatus 2, which is implemented when the power is turned on or the wireless LAN telephone terminal apparatus 2 moves to the service area and it recognizes the radio base station 1.

On completion of the registration of the telephone number and IP address with the call connection control server 3 in the registration phase a, the wireless LAN telephone terminal apparatus 2 moves to an intermittent reception state in which it receives only notice information from the radio base station 1. To be more specific, the radio base station 1 notifies the wireless LAN telephone terminal apparatus 2 of the notice information (line vacancy) in each timing of sending the notice information (b1 and b2 in FIG. 10).

In a state in which the IP telephone 5 or PC 6 associated with the wireless LAN telephone terminal apparatus 2 in advance makes a call request (b3 in FIG. 10), the call connection control server 3 transmits the call control information and line information on the IP telephone 5 or PC 6 to the wireless LAN telephone terminal apparatus 2 associated in advance (b4 in FIG. 10).

The call control information and line information are stored in a buffer of the radio base station 1 once, and are sent to the wireless LAN telephone terminal apparatus 2 in the next timing of sending the notice information (b5 in FIG. 10) so that the call control information and line information are shared between the wireless LAN telephone terminal apparatus 2 and the IP telephone 5 or PC 6.

During voice communication of the IP telephone 5 or PC 6, the call connection control server 3 transmits the call control information and line information on the IP telephone 5 or PC 6 to the radio base station 1 (b6 in FIG. 10). The radio base station 1 stores the call control information and line information in the buffer, and sends it to the wireless LAN telephone terminal apparatus 2 in the next timing of sending the notice information (b7 and b9 in FIG. 10).

In a state in which the IP telephone 5 or PC 6 makes a disconnection request (b8 in FIG. 10), on completion of the disconnection process (b10 in FIG. 10), the call connection control server 3 transmits the call control information and line information on the IP telephone 5 or PC 6 to the wireless LAN telephone terminal apparatus 2 (b11 in FIG. 10).

The call control information and line information are stored in the buffer of the radio base station 1 once, and are sent to the wireless LAN telephone terminal apparatus 2 in the next timing of sending the notice information (b12 in FIG. 10) so that the call control information and line information are shared between the wireless LAN telephone terminal apparatus 2 and the IP telephone 5 or PC 6.

Thus, according to this embodiment, the wireless LAN telephone terminal apparatus 2 can unify the management of the call originating/incoming history and telephone directory data with the IP telephone 5 or PC 6 on the desk.

According to this embodiment, the wireless LAN telephone terminal apparatus 2 synchronizes the call control information and line information with the IP telephone 5 or PC 6 on the desk so as to enhance mobility unique to the wireless apparatus without necessity of the cumbersome transfer operation even when leaving the desk during the voice communication.

In the above example, the wireless LAN telephone terminal apparatus 2 and the IP telephone 5 or PC 6 on the desk synchronize the call control information and line information. It is also possible, however, that the wireless LAN telephone terminal apparatus 2 and the IP telephone 5 or PC 6 on the desk synchronize peer-to-peer.

In this case, the wireless LAN telephone terminal apparatus 2 and the IP telephone 5 or PC 6 on the desk have terminal information for sharing the information registered therewith in advance respectively. The telephone directory data is provided by a method of synchronizing by a user operation and a method of synchronizing periodically. As for the information accompanying the call originating/incoming history, call state and calls, a protocol is defined in exchanging call control messages so as to pass the information as with the above-mentioned method of synchronizing via the call connection control server 3.

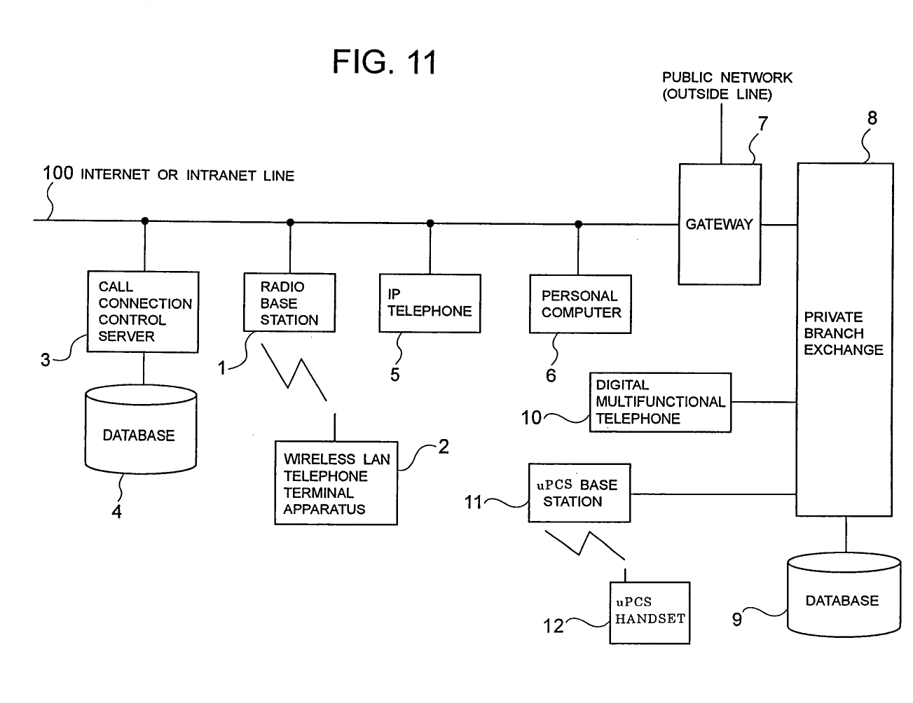

FIG. 11 is a block diagram showing the configuration of the network according to another embodiment of the present invention. In FIG. 11, the network according to the other embodiment of the present invention has the same configuration as the network according to the embodiment of the present invention shown in FIG. 1 except that a private branch exchange 8 is connected to a gateway 7 and that a digital multifunctional telephone 10 and a uPCS (unlicensed Personal Communication System) handset 12 connected thereto via a uPCS base station 11 synchronize the call control information and line information. And the same components are given the same symbols as in FIG. 1. The operations of the same components are the same as those in the embodiment of the present invention.

According to the embodiment of the present invention, the information is passed by the registration when the power of the wireless LAN telephone terminal apparatus 2 is turned on or the wireless LAN telephone terminal apparatus 2 moves to the service area. As opposed to this, according to the other embodiment of the present invention, the information is passed by location registration when the power of the uPCS handset 12 is turned on or the uPCS handset 12 moves to the service area.

As for the information accompanying the call state and calls, the uPCS handset 12 is connected to the network through the private branch exchange 8 and uPCS base station 11, and is triggered by change in the call state to give notice from the system (uPCS base station 11) with a no-sound call setting message.

To implement the operation whereby the digital multifunctional telephone 10 and uPCS handset 12 synchronize the call control information and line information, a processing operation of the call connection control server 3 in the above-mentioned embodiment of the present invention is performed by the private branch exchange 8 by using a database 9.

As described above, the present invention relates to the internal information sharing system including various device terminals having a telephone function and a control unit for making a call connection on the call origination and call termination by each of the various device terminals, wherein the information on the call control message is stored in the storage device together with the time information when sending and receiving the call control message between each of the various device terminals and the control unit, and when each of the various device terminals registers information with the control unit, the information already registered with the storage device is transmitted to each of the various device terminals so as to obtain the effect of unifying the management of the telephone directory data and call originating/incoming history.

What is claimed is:

1. An internal information sharing system including various device terminals having a telephone function and a control unit for making a call connection on call origination and call termination by each of said various device terminals, wherein said system has:
means for sending and receiving a call control message between each of said various device terminals and said control unit;
a storage device for storing information on said call control message together with time information; and
means for, when each of said various device terminals registers information with said control unit, transmitting the information already registered with said storage device to each of said various device terminals.

2. The internal information sharing system according to claim 1, wherein:
said various device terminals include at least one of an IP (Internet Protocol) telephone and an information processing apparatus having IP telephone software connected to an LAN (Local Area Network) line respectively and a wireless LAN telephone terminal apparatus capable of making voice communication with them by connecting to a wireless LAN line; and
said control unit is a call connection control server for making a call connection on the call origination and call termination by each of said various device terminals.

3. The internal information sharing system according to claim 2, wherein: when said wireless LAN telephone terminal apparatus moves to an external network, history information on call origination and call termination in said external network is stored in an storage area inside said wireless LAN telephone terminal apparatus; and when the wireless LAN telephone terminal apparatus registers its location with a network to which one of said IP telephone and said information processing apparatus belongs, the information stored in the storage area inside the wireless LAN telephone terminal apparatus is transmitted to said storage device.

4. The internal information sharing system according to claim 2, wherein, while said wireless LAN telephone terminal apparatus has its location registered with the network to which one of the IP telephone and said information processing apparatus belongs, said wireless LAN telephone terminal apparatus at least shares call control and line information with one of said IP telephone and said information processing apparatus.

5. The internal information sharing system according to claim 4, wherein, while said wireless LAN telephone terminal apparatus has its location registered with the network to which one of said IP telephone and said information processing apparatus belongs, said call control and line information are transmitted from said call connection control server to the wireless LAN telephone terminal apparatus.

6. The internal information sharing system according to claim 2, wherein said storage device is an external storage device connected to said call connection control server.

7. The internal information sharing system according to claim 2, wherein at least one of said IP telephone and said information processing apparatus and said wireless LAN telephone terminal apparatus mutually give and receive peer-to-peer the information stored in the storage area inside each of the apparatuses.

8. The internal information sharing system according to claim 1, wherein: said control unit is a private branch exchange for making a call connection on call origination and call termination by each of said various device terminals; and said various device terminals include a digital multifunctional telephone connected to said private branch exchange and a wireless terminal connected by a wireless line to a base station connected to said private branch exchange.

9. A call connection control server for making a call connection on call origination and call termination by at least one of an IP (Internet Protocol) telephone and an information processing apparatus having IP telephone software connected to an LAN (Local Area Network) line respectively and a wireless LAN telephone terminal apparatus capable of making voice communication with them by connecting to a wireless LAN line, wherein said server has:
means for sending and receiving a call control message to and from said wireless LAN telephone terminal apparatus;
a storage device for storing information on said call control message together with time information; and
means for, when said wireless LAN telephone terminal apparatus registers its location via said wireless LAN line, transmitting the information already registered with said storage device to said wireless LAN telephone terminal apparatus.

10. The call connection control server according to claim 9, wherein: when said wireless LAN telephone terminal apparatus moves to an external network, history information on call origination and call termination in said external network is stored in an storage area inside said wireless LAN telephone terminal apparatus; and when the wireless LAN telephone terminal apparatus registers its location with a network to which one of said IP telephone and said information processing apparatus belongs, the information stored in the storage area inside the wireless LAN telephone terminal apparatus is transmitted to said storage device.

11. The call connection control server according to claim 9, wherein, while said wireless LAN telephone terminal apparatus has its location registered with the network to which one of said IP telephone and said information processing apparatus belongs, said wireless LAN telephone terminal apparatus at least shares call control and line information with one of said IP telephone and said information processing apparatus.

12. The call connection control server according to claim 11, wherein, while said wireless LAN telephone terminal apparatus has its location registered with the network to which one of said IP telephone and said information processing apparatus belongs, said call control and line information are transmitted from said call connection control server to the wireless LAN telephone terminal apparatus.

13. The call connection control server according to claim 9, wherein an external storage device connected to the call connection control server is used as said storage device.

14. A wireless LAN telephone terminal apparatus capable of making voice communication by connecting via a wireless LAN line to at least one of an IP (Internet Protocol) telephone and an information processing apparatus having IP telephone software connected to an LAN (Local Area Network) line respectively wherein said wireless LAN telephone terminal apparatus has:
means for sending and receiving a call control message to and from a call connection control server for making a call connection on call origination and call termination by at least one of said IP telephone and said information processing apparatus; and
means for, when the information already registered with a storage device for storing information on said call control message together with time information is transmitted to the wireless LAN telephone terminal apparatus on registering a location of the wireless LAN telephone terminal apparatus via said wireless LAN line, storing the information in an internal storage area.

15. The wireless LAN telephone terminal apparatus according to claim 14, wherein said wireless LAN telephone terminal apparatus includes: means for, when the wireless LAN telephone terminal apparatus moves to an external network, storing in said internal storage area history information on call origination and call termination in said external network; and means for, when registering the location with a network to which one of said IP telephone and said information processing apparatus belongs, transmitting to said storage device the information stored in said internal storage area.

16. The wireless LAN telephone terminal apparatus according to claim 14, wherein, while the location is registered with the network to which one of said IP telephone and said information processing apparatus belongs, at least call control and line information are shared with one of said IP telephone and said information processing apparatus.

17. The wireless LAN telephone terminal apparatus according to claim 16, wherein, while the location is registered with the network to which one of said IP telephone and said information processing apparatus belongs, said call control and line information from said call connection control server are registered in said internal storage area.

18. The wireless LAN telephone terminal apparatus according to claim 14, wherein said storage device is an external storage device connected to said call connection control server.

19. The wireless LAN telephone terminal apparatus according to claim 14, wherein at least one of said IP telephone and said information processing apparatus and said wireless LAN telephone terminal apparatus mutually give and receive peer-to-peer the information stored in the storage area inside each of the apparatuses.

20. An internal information sharing method of a system including various device terminals having a telephone function and a control unit for making a call connection on call origination and call termination by each of said various device terminals, wherein said method has:
a step of sending and receiving a call control message between each of said various device terminals and said control unit; and
a step of, when each of said various device terminals registers information with said control unit, transmitting to each of said various device terminals the information already registered with a storage device for storing information on said call control message together with time information.

21. The internal information sharing method according to claim 20, wherein:
said various device terminals include at least one of an IP (Internet Protocol) telephone and an information processing apparatus having IP telephone software connected to an LAN (Local Area Network) line respectively and a wireless LAN telephone terminal apparatus capable of making voice communication with them by connecting to a wireless LAN line; and
said control unit is a call connection control server for making a call connection on the call origination and call termination by each of said various device terminals.

22. The internal information sharing method according to claim 21, wherein: when said wireless LAN telephone terminal apparatus moves to an external network, history information on call origination and call termination in said external network is stored in an storage area inside said wireless LAN telephone terminal apparatus; and when the wireless LAN telephone terminal apparatus registers its location with a network to which one of said IP telephone and said information processing apparatus belongs, the information stored in the storage area inside the wireless LAN telephone terminal apparatus is transmitted to said storage device.

23. The internal information sharing method according to claim 21, wherein, while said wireless LAN telephone terminal apparatus has its location registered with the network to which one of said IP telephone and said information processing apparatus belongs, said wireless LAN telephone terminal apparatus at least shares call control and line information with one of said IP telephone and said information processing apparatus.

24. The internal information sharing method according to claim 23, wherein, while said wireless LAN telephone terminal apparatus has its location registered with the network to which one of said IP telephone and said information processing apparatus belongs, said call control and line information is transmitted from said call connection control server to the wireless LAN telephone terminal apparatus.

25. The internal information sharing method according to claim 21, wherein said storage device is an external storage device connected to said call connection control server.

26. The internal information sharing method according to claim 20, wherein:
said control unit is a private branch exchange for making a call connection on call origination and call termination by each of said various device terminals; and
said various device terminals include a digital multifunctional telephone connected to said private branch exchange and a wireless terminal connected by a wireless line to a base station connected to said private branch exchange.

27. A program of an internal information sharing method of a system including various device terminals having a telephone function and a control unit for making a call connection on call origination and call termination by each of said various device terminals, wherein said program causes a computer to execute:
a process of sending and receiving a call control message between each of said various device terminals and said control unit; and
a process of, when each of said various device terminals registers information with said control unit, transmitting to each of said various device terminals the information already registered with said storage device for storing the information on said call control message together with time information.
